(19) United States
(12) Patent Application Publication
(10) Pub. No.: US 2010/0122577 A1
(43) Pub. Date: May 20, 2010

(54) EVALUATION ELECTRONICS SYSTEM FOR A ROTATION-RATE SENSOR

(76) Inventors: Reinhard NEUL, Stuttgart (DE); Thorsten Balslink, Reutlingen (DE)

Correspondence Address: KENYON & KENYON LLP, ONE BROADWAY, NEW YORK, NY, 10004, US

(21) Appl. No.: 12/618,314

(22) Filed: Nov. 13, 2009

(30) Foreign Application Priority Data
Nov. 14, 2008 (DE) 102008043742.5

(51) Int. Cl. G01C 19/56

(52) U.S. Cl. 73/504.12

(57) ABSTRACT

An evaluation electronics system for a rotation-rate sensor, having a first and a second seismic mass, is developed for the purpose of ascertaining a rotation rate, acting on the rotation-rate sensor, from a deflection of the first and second seismic masses. The evaluation electronics system, in this instance, has a regulation member in order to minimize an undesired deflection of the first and second seismic masses, caused by interference influences.

### BACKGROUND INFORMATION

Rotation-rate sensors for ascertaining rotation rates, about one or more measuring axes, are known from the related art. In known micromechanical rotation-rate sensors, two or more seismic masses are driven in such a way that they execute an antiparallel vibration. If a rotation rate occurs about a stipulated measuring axis, the seismic masses are deflected in an antiparallel manner by Coriolis forces, perpendicular to the drive direction. These deflections are detected using an evaluation electronics system, and they supply a measure for the rotation rate that is to be measured.

In rotation-rate sensors according to the related art, the sensitivity of the rotation-rate sensors to vibrations in the deflection direction of the seismic masses is observed in a frequency range of a few Hz up to a few kHz. An external vibration causes a motion of the seismic masses at the frequency of the external spurious response. The measurement of the rotation rate acting on the rotation-rate sensor may thereby be impaired.

### SUMMARY OF THE INVENTION

It is an object of the present invention to provide an improved evaluation electronics system for a rotation-rate sensor. This objective is attained by an evaluation electronics system for a rotation-rate sensor according to the present invention.

An evaluation electronics system for a rotation-rate sensor according to the present invention, having a first and a second seismic mass, is developed for the purpose of ascertaining a rotation rate acting on the rotation-rate sensor, from a deflection of the first and the second seismic masses. The evaluation electronics system, in this instance, has a regulation member in order to minimize an undesired deflection of the first and second seismic masses, caused by interfering influences. The vibration sensitivity of the rotation-rate sensor may advantageously be reduced thereby. An additional advantage is that the evaluation electronics system according to the present invention is suitable for use with all types of rotation-rate sensors.

The rotation-rate sensor expediently has a drive mechanism that is developed to excite the first and second seismic masses to an antiparallel vibration along a drive direction. In this context, the first and second seismic masses are able to be deflected along a measuring direction which is oriented essentially perpendicular to the drive direction. Detection means are provided, furthermore, for detecting a deflection of the first and second seismic masses along the measuring direction. In addition, compensation means are provided for compensating for an undesired deflection of the first and second seismic masses. It is advantageous that an intermodulation of drive frequencies and interference frequencies is suppressed by this design.

The first and second seismic masses, the detection means, the regulation member and the compensation means preferably form a control loop. This advantageously permits a captive operation of the acceleration sensors formed by the first and second seismic masses.

The drive mechanism is expediently an electrostatic or piezoelectric drive mechanism.

In one specific embodiment, the detection means are developed to ascertain a deflection of the first and second seismic masses because of capacitance changes between the first and second seismic masses and first and second counter-electrodes situated on a substrate surface. This makes possible the use of an evaluation electronics system together with known rotation-rate sensors.

The compensation means in this specific embodiment are expediently developed to compensate for an undesired deflection of the first and second seismic masses by applying an electrical voltage between the first and second seismic masses and the first and second counter-electrodes situated on the substrate surface. This advantageously makes possible a compensation for undesired deflections without additional components being required.

In another specific embodiment, the detection means are developed to detect a deflection of the first and second seismic masses with the aid of a change in an electrical characteristics variable of at least one piezoelectric element.

The compensation means in this specific embodiment are expediently developed to compensate for an undesired deflection of the first and second seismic masses by the application of an electric voltage to the at least one piezoelectric element. In this case, too, advantageously no additional components will be required for compensating for undesired deflections.

In one refinement, the rotation-rate sensor has a mechanical low-pass filter, the evaluation electronics system being developed to minimize an undesired deflection of the first and second seismic masses in a frequency range of 0 Hz up to above a cutoff frequency of the mechanical low-pass filter. In this specific embodiment, the evaluation electronics system and the mechanical low-pass filter advantageously complement each other.

According to one additional refinement, the evaluation electronics system is developed for ascertaining an acceleration acting on the rotation-rate sensor in the measuring direction. It is advantageously made possible, thereby, to use the rotation-rate sensor as an acceleration sensor.

### BRIEF DESCRIPTION OF THE DRAWINGS

FIG. 1 schematically shows a top view onto a rotation-rate sensor.

FIG. 2 shows a schematic block diagram of an evaluation electronics system for recording the Coriolis acceleration for a rotation-rate sensor.

### DETAILED DESCRIPTION

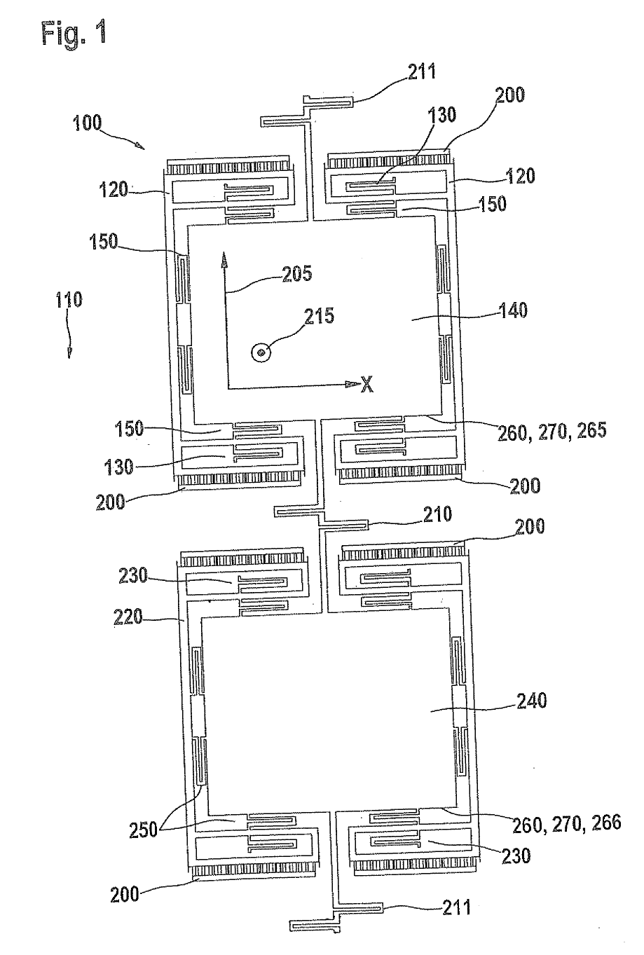

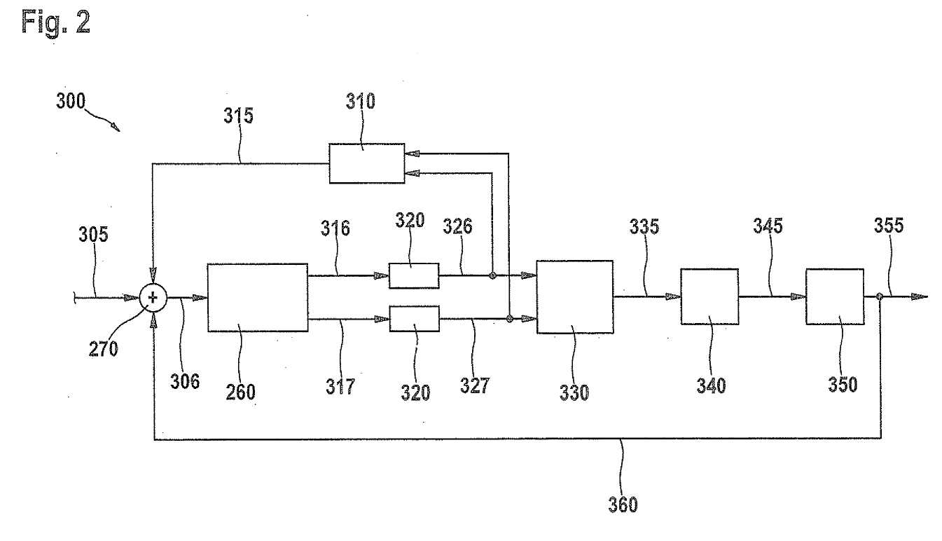

FIG. 1 shows a schematic top view onto a micromechanical rotation-rate sensor 100, which is able to be used together with an evaluation electronics system 300, shown in FIG. 2. However, rotation-rate sensor 100 shown in FIG. 1 only represents an example. An evaluation electronics system 300 of FIG. 2 is suitable for use with any type of vibrating rotation-rate sensors. In particular, an evaluation electronics system 300 may also be used in connection with rotation-rate sensors that are provided for the detection of rotation rates about other rotational axes than the one in FIG. 1.

Rotation-rate sensor 100 is situated above a surface of a substrate 110. Substrate 110 may be a silicon substrate, for example. The surface of substrate 110 is situated in a plane that is generated by an x direction and a drive direction 205 perpendicular to it. A measuring direction 215 is oriented perpendicular to the substrate surface, that is, also perpendicular to the x direction and drive direction 205.

Rotation-rate sensor 100 includes a first frame 120 and a second frame 220. First frame 120 is connected to substrate 110 via first spring elements 130. First spring elements 130 permit a motion of first frame 120 along drive direction 205. Second frame 220 is connected to substrate 110 via second spring elements 230. The second spring elements 230 permit a motion of second frame 220 along drive direction 205. First spring elements 130 and second spring elements 230 may be developed as bar springs, for instance.

First frame 120 and second frame 220 are able to be set into antiparallel vibration along drive direction 205, using a drive mechanism 200. The antiparallel vibration may be developed in such a way that first frame 120 and second frame 220 move away from each other during a first vibration phase and move towards each other during a second vibration phase. In this context, the drive vibration may have a frequency of some 10 kHz, for instance, 15 kHz. Drive mechanism 200 may be an electrostatic or a piezoelectric drive mechanism. Such drive mechanisms are familiar from the related art.

Rotation-rate sensor 100 further includes a first seismic mass 140 which is situated above the surface of substrate 110, in an area bordered by first frame 120. First seismic mass 140 is connected to first frame 120 via third spring elements 150. Rotation-rate sensor 100 also includes a second seismic mass 240 which is situated above the surface of substrate 110, bordered by second frame 220, and is connected to second frame 220 via fourth spring elements 250. First seismic mass 140 and second seismic mass 240 are connected to each other via a fifth spring element 210. In addition, first and second seismic masses 140, 240 are each connected to substrate 110 via sixth spring elements 211. Third, fourth, fifth and sixth spring elements 150, 250, 210, 211 may be bar springs. Third spring elements 150 and fourth spring elements 250 are developed in the drive direction in such a stiff manner that first and second seismic masses 140, 240 follow drive motions of first and second frame 120, 220 in drive direction 205. Besides that, third and fourth spring elements 150, 250 are designed so that first and second seismic masses 140, 240 are able to be deflected along measuring direction 215 against first and second frame 120, 220. First and second seismic masses 140, 240 thus are able to move perpendicular to the substrate surface, away from substrate 110, or towards substrate 110.

If a rotation rate acts on rotation-rate sensor 100, about an axis of rotation that is parallel to the x direction, while first and second frames 120, 220 are carrying out an antiparallel vibration, the rotation rate brings about, in measuring direction 215, Coriolis forces that have an effect on first and second seismic masses 140, 240. The direction of the Coriolis forces acting on first and second seismic masses 140, 240, in this instance, is a function of the direction of rotation and the directions of motion of first and second seismic frames 120, 220. In one vibrational phase, during which the first and the second frame 120, 220 move away from each other, a force, for example, may act on first seismic mass 140, which points away from substrate 110, while a force in a direction towards the substrate acts on second seismic mass 240. In a vibrational phase during which first and second frame 120, 220 move towards each other, a Coriolis force then acts on first seismic mass 140 in the direction of substrate 110, while a Coriolis force pointing away from substrate 110 acts on second seismic mass 240. The Coriolis forces acting on the first and second seismic masses 140, 240 cause periodic deflections of first and second seismic masses 140, 240 along measuring direction 215 at the frequency of the drive motion effected by drive mechanism 200. The amplitudes of these deflections, in measuring direction 215, represent a measure for the magnitude of the rotation rate acting on rotation-rate sensor 100.

Rotation-rate sensor 100 includes detection means 260 for detecting a deflection of first and second seismic masses 140, 240 along measuring direction 215. Detection means 260 may be electrostatic detection means, for example. A first counter-electrode 265 may be situated on substrate 110, for instance, below first seismic mass 140, and a second counter-electrode 266 may be situated on substrate 110 below second seismic mass 240. In this case, first seismic mass 140 and first counter-electrode 265 form a first capacitor, whose capacitance is a function of the distance of first seismic mass 140 from first counter-electrode 265, that is connected to substrate 110. Second seismic mass 240 and second counter-electrode 266 form a second capacitor, whose capacitance changes in response to the deflection of second seismic mass 240 in measuring direction 215. By a measurement and evaluation of the capacitances of the first and second capacitors, one is able to draw a conclusion on the deflections of the first and second seismic masses 140, 240 effected by the Coriolis forces, and because of that, on a rotation rate acting on rotation-rate sensor 100. By the application of electrical voltages to the first and the second counter-electrodes 265, 266, deflections of first and second seismic masses 140, 240 in measuring direction 215 may also be specifically influenced. This being the case, first and second counter-electrodes 265, 266 also represent a compensation means 270. In another specific embodiment of the present invention, detection means 260 and compensation means 270 may also be formed by piezoelectric elements which may, for example, be situated at suspension springs 150, 250. In this specific embodiment, during a deflection of first and second seismic masses 140, 240 along the measuring direction 215, there is a change in an electrical characteristics variable, such as a voltage, a load or a resistance. By applying electric voltages to the piezoelectric elements, deflections of first and second seismic masses 140, 240 may also be specifically influenced.

Accelerations acting on rotation-rate sensor 100 in measuring direction 215 are also able to lead to a deflection of first and second seismic masses 140, 240 in measuring direction 215. Such accelerations may, for instance, originate with vibrations in measuring direction 215. For damping such vibrations, rotation-rate sensor 100 may be situated on a mechanical low-pass filter. Such mechanical low-pass filters are known from the related art, but they work only above a certain minimum frequency, for example, above a few kHz. Vibrations having a low frequency were not sufficiently damped.

Coriolis forces effected by a rotation rate lead to deflections of first and second seismic masses 140, 240 that are in phase opposition or antiparallel. On the other hand, a vibration acting on rotation-rate sensor 100 causes parallel or in-phase deflections of seismic masses 140, 240 to the frequency of vibration, which may be in a range of up to 4 kHz, for example. An evaluation electronics system connected to rotation-rate sensor 100 does not react to such direct component signals. However, the mechanical structure of rotation-rate sensor 100 also vibrates without interference vibrations, not only with the antiparallel drive frequency but proportionally also with other adjacent forms of vibration, for instance, of a parallel phase resonance. Under the influence of interference vibrations, there is an intermodulation of the partaking frequencies at the nonlinear characteristics curve of detection means 260. Mixed products created thereby may hit the operating frequency of rotation-rate sensor 100 by convolution. In this case, there is a vibration sensitivity of rotation-rate sensor 100 since, because of the influence of the interference vibrations, a corruption of the vibration of first and second seismic masses 140, 240 is created at the drive frequency of rotation-rate sensor 100.

The vibration sensitivity of rotation-rate sensor 100 is reduced by an evaluation electronics system 300 shown in FIG. 2, by reducing or suppressing the direct component motions of seismic masses 140, 240, effected by interference vibrations, by a regulated or captive operation of an evaluation electronics system 300. Direct component motions in the frequency range between 0 Hz to barely above the cutoff frequency of a possibly present low-pass filter should expediently be suppressed.

In an evaluation electronics system 300, detection means 260 detects a first capacitance 316 of the first capacitor formed by first seismic mass 140 and first counter-electrode 265 and a second capacitance 317 of the second capacitor formed by second seismic mass 240 and second counter-electrode 266. If detection means 260 is a piezoelectric detection means, detection means 260 instead detects electrical characteristics variables of the piezoelectric detection means. First capacitance 316 and second capacitance 317 are converted to first and second voltages 326, 327, that are proportional to capacitances 326, 327, by a capacitance/voltage converter 320. A differential element 330 gathers an analog differential signal 335 from the difference between first voltage 326 and second voltage 327. An analog/digital converter 340 converts the analog differential signal 335 to a digital differential signal 345. Via a controller 350, digital differential signal 345 is fed back via a feedback 360 and compensation means 270 as a force to seismic masses 140, 240, and at the same time is available as Coriolis acceleration 355 for a subsequent synchronous demodulation and low-pass filtering for determining the rotation rate.

In addition, an evaluation electronics system 300 includes a regulation member 310 which generates a compensation signal 315 from first voltage 326 and second voltage 327. Regulation member 310 has a sufficiently high amplification at low frequencies so as, because of the control function, to hold the motions of seismic masses 140, 240 sufficiently small, based on interference accelerations, at sufficiently small phase rotation, so that the stability of the control loop is ensured. Furthermore, at the resonance points of the mechanical sensor structure of rotation-rate sensor 100, particularly at the parallel resonance of seismic masses 140, 240, regulation member 310 has a sufficiently high damping so that the loop gain of the open control loop does not exceed the factor 1 in this frequency range, and the control loop remains stable at these points. Compensation signal 315 is supplied to compensation means 270 in order to achieve the compensation for undesired interference deflections of the first and second seismic masses 140, 240. If compensation means 270 is formed by capacitors made up of seismic masses 140, 240 and counter-electrodes 265, 266, compensation means 270 is able to compensate for undesired interference deflections of seismic masses 140, 240, for instance, by applying suitable voltages to the capacitors.

The compensations for undesired deflections of seismic masses 140, 240, undertaken by compensation means 270, puts active forces onto seismic masses 140, 240 which superpose themselves to form an overall force 306, together with Coriolis forces 305 effected by a rotation rate acting on rotation-rate sensor 100. This overall force 306 determines the effective deflections of first and second seismic masses 140, 240 which, in turn, are detected by detection means 260. First and second seismic masses 140, 240, detection means 260, regulation member 310 and the compensation means 270 thereby form a control loop.

Besides the described use for the detection of rotation rates, rotation-rate sensor 100 explained with the aid of FIG. 1, and an evaluation electronics system 300 explained with the aid of FIG. 2, additionally offer the possibility of using first and second seismic masses 140, 240 for the detection of accelerations, acting on rotation-rate sensor 100 in measuring direction 215, in the frequency range between 0 Hz and the cutoff frequency of the mechanical low-pass filter.

What is claimed is:

1. An evaluation electronics system for ascertaining a rotation rate acting on a rotation-rate sensor from a deflection of first and second seismic masses of the sensor, the system comprising:
a regulation member adapted to minimize an undesired deflection of the first and second seismic masses effected by interference influences.

2. The evaluation electronics system of claim 1, wherein the rotation-rate sensor has a drive mechanism for exciting the first and second seismic masses to an antiparallel vibration along a drive direction, the first and second seismic masses being able to be deflected along a measuring direction, the measuring direction being oriented substantially perpendicular to the drive direction, the system further comprising:
detection means for detecting a deflection of the first and second seismic masses along the measuring direction; and
compensation means for compensating for an undesired deflection of the first and second seismic masses.

3. The evaluation electronics system of claim 2, wherein the first and the second seismic masses, the detection means, the regulation member and the compensation means form a control loop.

4. The evaluation electronics system of claim 2, wherein the drive mechanism is an electrostatic or a piezoelectric drive mechanism.

5. The evaluation electronics system of claim 2, wherein the detection means ascertains a deflection of the first and second seismic masses on the basis of capacitance changes between the first and second seismic masses and first and second counter-electrodes situated on a substrate surface.

6. The evaluation electronics system of claim 5, wherein the compensation means compensates for an undesired deflection of the first and second seismic masses by applying electric voltages between the first and second seismic masses and the first and second counter-electrodes situated on the substrate surface.

7. The evaluation electronics system of claim 2, wherein the detection means detects a deflection of the first and second seismic masses on the basis of a change in an electrical characteristics variable of at least one piezoelectric element.

8. The evaluation electronics system of claim 7, wherein the compensation means compensates for an undesired deflection of the first and second seismic masses by applying an electric voltage to at least one piezoelectric element.

9. The evaluation electronics system of claim 1, wherein the rotation-rate sensor has a mechanical low-pass filter, the evaluation electronics system minimizing an undesired deflection of the first and second seismic masses in a frequency range of 0 Hz up to above a cutoff frequency of the mechanical low-pass filter.

10. The evaluation electronics system of claim 1, wherein the evaluation electronics system ascertains an acceleration acting on the rotation-rate sensor in a measuring direction.
